(19) United States
(12) Patent Application Publication
(10) Pub. No.: US 2015/0331633 A1
(43) Pub. Date: Nov. 19, 2015

(54) METHOD AND SYSTEM OF CACHING WEB CONTENT IN A HARD DISK

(71) Applicant: TELEFONICA, S.A., Madrid (ES)

(72) Inventors: Xiaoyuan Yang, Madrid (ES); Ivan Levi Martin, Madrid (ES); Eguzki Astiz Lezaun, Madrid (ES); Armando Antonio García Sánchez Mendoza, Madrid (ES); David Guijarro Guillen, Madrid (ES); Arcadio Pando Cao, Madrid (ES); Maite Burrel Diez, Madrid (ES); David Conejero Olesti, Madrid (ES)

(73) Assignee: TELEFONICA, S.A., Madrid (ES)

(21) Appl. No.: 14/653,705

(22) PCT Filed: Dec. 18, 2013
(86) PCT No.: PCT/EP2013/077158

§ 371 Date: Jun. 18, 2015

(30) Foreign Application Priority Data
Dec. 18, 2012 (EP) 12382510.1

(51) Int. Cl. G06F 3/06

(52) U.S. Cl. CPC G06F 3/0644; G06F 3/0604; G06F 3/0674

(57) ABSTRACT

A method and system of storing and retrieving web content in a cache hard disk memory, in which read requests and write requests are separated in two different queues, and read requests are prioritized. This way, write requests are selectively delayed to favour read operations and improve user experience.

### CROSS-REFERENCE TO RELATED APPLICATIONS

This application is a national stage application, and claims the benefit of priority, of International Patent Application No. PCT/EP2013/077158, filed Dec. 18, 2013, and entitled “Method And System of Caching Web Content In A Hard Disk,” which claims the benefit of priority of European patent application EP 12382510.1, filed Dec. 18, 2012, each of which is incorporated herein by reference in its entirety and for all purposes.

### TECHNICAL FIELD

The present described embodiments have application within the telecommunication sector, and especially, in the area of web content provisioning.

### BACKGROUND

In order to minimize delivery delays when a user request a web content to an internet server, communication networks are typically distributed in a system of intermediate nodes. Instead of delivering the requested web content directly from the server to the end user, the requested context is cached in the intermediate nodes. However, the storing capacity of the intermediate nodes is limited, and not all the information from every server can be duplicated in every single node. For this reason, the data stored in a node is constantly updated in an effort to comprise the most popular and request web content, typically following a Least Recently Used (LRU) replacing policy.

In order to maximize the speed at which the node provide cached web content to an end user, the nodes typically comprise two different kinds of storage media: a fast Random Access Memory (RAM), and a slower hard disk (HD). If the node needs to deliver content from the hard disk, the web caching system of the node needs to first store the requested content in the RAM, replacing any other contents stored in the RAM to free the required space. Therefore, the web caching system of the node constantly reorganizes web content in both storage media, in an effort to keep the most popular content in the RAM, and the rest of the popular content in the HD. Also, content downloaded from the server through the RAM of the node needs to be copied to the HD to minimize data loss in case of power outages.

HD management systems are required to handle simultaneously read and write operations. Since conventional web caching systems treat both types of operations equally, read requests can be delayed when operating under heavy activity. As users only perceive the delay in read operations, but are unaware of when writing operations occur in the HD, this results in a deterioration of the overall performance perceived by the user.

Several proposals have been made in order to increase the performance of hard disk based storage systems and reduce the average delay suffered in the provisioning of a web content requested by a user. For example, the performance of a hard disk strongly depends on how the mechanical read and write headers are moved across the disk to fetch and write data. For this reason, various scheduling policies have been proposed to optimize the aggregated disk throughput, such as SCAN (elevator algorithm), FCFS (First come first serve) and SSTF (Shortest seek time first). For real time applications, Earliest Deadline First (EDF) policies are typically applied. However, these policies are designed for general purposes and do not take into account the specific characteristics of the web content being read/written in intermediate nodes, and therefore, they do not optimize user experience in web caching systems.

A different strategy to optimize HD performance is to improve the hardware performance of the device, using faster storage technologies. For example, US 2010/0199036 A1 presents a hierarchical classification of multiple hard disks, sorted according to their access rate. The most popular data is therefore allocated in the fastest hard disks, thus minimizing the average delay of a read request. Also, US 2010/0235569 A1 optimizes a solid state memory lifespan by distributing write operations fairly across the physical memory, avoiding hot spots that may damage the device. These techniques are transparent to the web caching scheduling, and therefore compatible with any web caching system.

Various object replacement schemes have been devised to replace basic LRU algorithms and optimize the data that is kept in a memory when said memory becomes saturated and new data needs to be written. For example, U.S. Pat. No. 6,266,742 B1 maximizes the efficiency of caching systems by using a metric that takes into account access frequency, size, lifetime and time to fetch of an object. U.S. Pat. No. 6,425,057 B1 propose the inclusion of a probability function to evaluate the cost of keeping or replacing an object in the cache. U.S. Pat. No. 6,772,199 B1 allow applications to define the criteria for cache replacement. These techniques improve cache memory usage by optimizing the data that is stored in the memory, but do not affect the time required to access said memory in a read operation. Therefore, read operations can still be delayed by write operations in scenarios of heavy activity, and the user experience can be degraded.

Therefore, there is a need in the state of the art for a method and system of caching web content in intermediate nodes equipped with hard disks that improve the average delay of web content delivery to a user, regardless of the hardware architecture and the replacing policy of said node.

### SUMMARY OF THE DISCLOSURE

The present disclosure solves the aforementioned problems by disclosing a method, system and computer program that prioritizes read operations versus write operations, therefore reducing the delay suffered by web content retrieval requests and improving the user experience.

In a first aspect of the present disclosure, a method of caching web content in a node with a hard disk is disclosed. According to the disclosed method, write requests of web content issued to the hard disk are queued in a first queue with a lower priority, whereas read requests of web content issued to said hard disk are queued through a second queue with a greater priority. Therefore, read requests are prioritized when scheduling access requests to the hard disk, and the average delay when providing web content to a user is reduced. Preferably, the method further comprises monitoring a saturation level of the hard disk, that is, the relation between an actual data throughput in relation to the maximum data throughput of the hard disk. The information about the saturation level is then applied to the scheduling of read and write requests coming out of their respective queues, always maintaining a greater priority for read operations. More preferably, no write operations queued at the write operations queue are scheduled unless the saturation level of the device is below a given first threshold. Therefore, the hard disk is only accessed to write web content when said hard disk is not saturated, and can still provide requested web content without an increased delay.

Preferably, the method comprises scheduling multiple writing operations when the hard disk saturation level is below a given second threshold. Therefore, in scenarios with low hard disk activity, multiple write operations can be simultaneously scheduled to also optimize the delay of web content storing operations.

Preferably, the queue for write requests is a first-in first-out (FIFO) queue. Also preferably, requests in said queue are divided into data blocks of a constant size. This allows to progressively store web content in the hard disk using the remaining data throughput allowed by read operations, in scenarios where said remaining data throughput would not be enough to store a whole web content object without delaying read operations.

Since write requests can be indefinitely delayed in their queue when a continuous flow of read requests is present, the method preferably comprises checking an expiration of said write requests, and removing from the queue any expired request.

In a second aspect of the present disclosure, a system of caching web content in a node with a hard disk is presented. The system comprises:

First scheduling means, which queue read requests of web content cached in the hard disk of the node in a first queue, and write requests to cache web content in said hard disk in a second queue. Preferably, the queue for write request is a FIFO queue, and queued web content is divided into data blocks with a fixed size.

Preferably, monitoring means adapted to measure a data throughput of a hard disk.

Second scheduling means, which schedule read and write requests queued at the two queues, giving a greater priority to the queue of read requests. Preferably, the second scheduling means perform the scheduling of write and read requests according to the monitored data throughput of the hard disk. More preferably, the second scheduling means are configured to only schedule queued write requests when the data throughput is below a given first threshold, that is, when the hard disk is not saturated. Also preferably, more than one write request can be scheduled simultaneously when the monitored data throughput is below a second threshold (lower than the first threshold). Preferably, the second scheduling means verify an expiration of queued write requests and dismiss any expired requests.

In a third aspect of the present disclosure, a computer program is disclosed, comprising computer program code means adapted to perform of the described method when said program is run on a computer, a digital signal processor, a field-programmable gate array, an application-specific integrated circuit, a micro-processor, a micro-controller, or any other form of programmable hardware.

With the disclosed method, system, and computer program, the average time required to deliver any web content cached in the hard disk of an intermediate node is reduced, optimizing the user experience provided by the web caching service. Additionally, the disclosed embodiments can be applied to any hard-disk-based web caching system, since it is completely independent of hardware characteristics, allocation criteria, and replacement schemes. These and other advantages will be apparent in the light of the detailed description.

### BRIEF DESCRIPTION OF THE DRAWINGS

For the purpose of aiding the understanding of the characteristics of the presently described embodiments, according to a preferred practical embodiment thereof and in order to complement this description, the following figures are attached as an integral part thereof, having an illustrative and non-limiting character:

FIG. 1 shows a schematic of a conventional intermediate node for web caching.

FIG. 2 presents a schematic of an intermediate node for web caching comprising a preferred embodiment of the system.

FIG. 3 is a flow diagram dealing with a new read request, according to a preferred embodiment of the method.

FIG. 4 shows a scheme of the queuing and scheduling system according to a preferred embodiment of the system.

### DETAILED DESCRIPTION

The matters defined in this detailed description are provided to assist in a comprehensive understanding of the described embodiments. Accordingly, those of ordinary skill in the art will recognize that variation changes and modifications of the embodiments described herein can be made without departing from the scope and spirit of the described embodiments. Also, description of well-known functions and elements are omitted for clarity and conciseness.

Note that in this text, the term “comprises” and its derivations (such as “comprising”, etc.) should not be understood in an excluding sense, that is, these terms should not be interpreted as excluding the possibility that what is described and defined may include further elements, steps, etc.

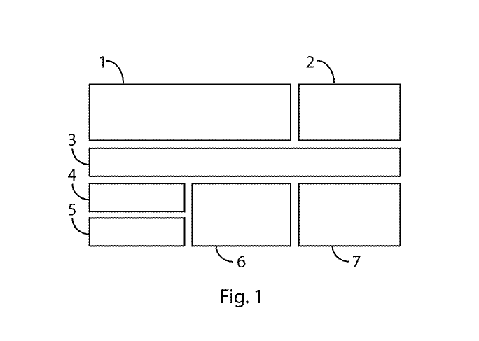

FIG. 1 presents the architecture of a conventional intermediate node for web content caching in a communication network. The node comprises a web caching application (1), which is in charge of managing web content requests from users, requesting web content to a remote server, and generating read and write requests to the data storage media of the node, that is, a RAM memory and a hard disk. The node may also comprise any other additional application (2). The node further comprises kernel application programming interfaces (3) to manage the different resources of the operating system of the node, such as a central processing unit (CPU) scheduler (7). Both the web caching application (1) and any other additional application (2) share the system memory through a memory manager (6) that also implements, typically, virtual memory and memory access protection. All devices are accessed through specific device drivers (4). A file system (5) manages all hard disks and offers the logical new of disks, in form of files and directories.

In conventional web caching systems, in order to access files in hard disks, the web caching application (1) calls different kernel APIs (3), but all calls are treated uniformly because operating systems are typically designed to provide a fair service to all applications. Being agnostic to the characteristics of each application, web caching applications (1) implemented in conventional storage systems can suffer unnecessary response time degradations due to sudden disk write operations.

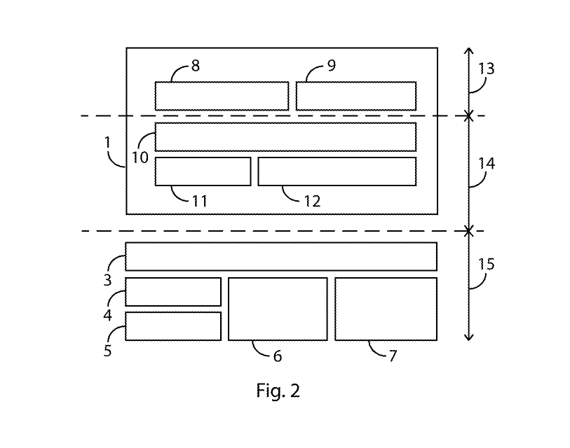

FIG. 2 presents a schematic of a web caching application (1) implemented in an intermediate node according to the system and method of the described embodiments. The described embodiments use a conventional web caching network delivery plane (13) while only affecting the web caching object management (14). The operating system plane (15) is also unaffected by the described embodiments. As any other web caching system, web caching network delivery plane (13) comprises a request manager (8) and a download manager (9). The request manager (1) is in charge of accepting web content requests (typically hypertext transfer protocol, HTTP, requests) from end users and generating the required answer. The download manager (2) is responsible of generating requests to the origin servers to retrieve web content missing in the intermediate node.

The web caching object management (14) plane comprises a web caching object pool (10), which acts as first scheduling means; a device performance monitor (11), which monitors the data throughput of the hard disk, and therefore its saturation level; and an object persistence manager (12) which acts as second scheduling means.

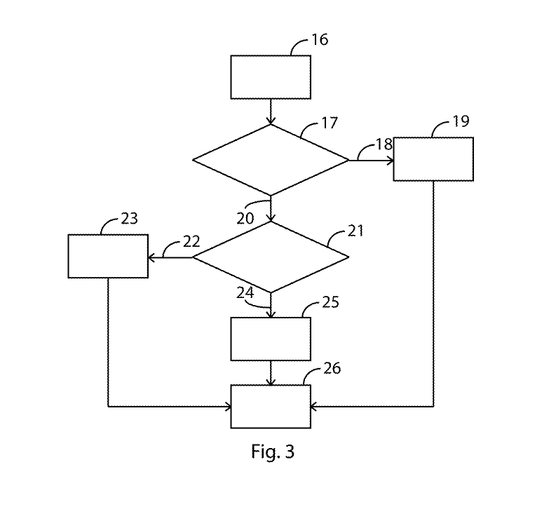

FIG. 3 shows in greater detail the operation of the web caching object pool (10). When a request of web content is received (16) at the node, the web caching object pool (10) checks (17) if said web content is cached in the node (either in the RAM or in the hard disk). If the content is not cached (18), a request to the download manager (9) is issued (19), and said download manager (9) requests the web content to the origin servers. The web caching object pool (10) finishes (26) the process until the content is received from the server.

If the requested web content is cached in the node (20), the web caching object pool (10) verifies (21) if said web content is stored in the RAM. If not (22), a request to retrieve the web content is sent (23) to the object persistence manager (12). Otherwise (24), the web content is delivered (25) to the user from the RAM. In both cases, the process at the web caching object pool (10) finishes (26).

Additionally, the web caching object pool (10) manages all stored web content objects in the node, tracks a fixed amount of RAM memory, and keeps the most popular web content cached in the RAM according to any of the object replacement policies for cached data known in the state of the art. When the web caching object pool (10) determines that a web content that is stored in the RAM is to be removed, the web caching object pool (10) checks if the web content object is already stored in the hard disk. If that is the case, the web content is simply removed from the RAM and no further actions are taken. If the object is not stored in the RAM, and according to particular embodiments, the caching object pool (10) may decide to store it in the hard disk, or not to take further actions, in which case the object is effectively removed from web caching at the node and the next request for said object will generate a new request to the origin server.

Once a web content object is downloaded from the origin server, the download manager (9) informs the web caching object pool (10) of the reception of the new object. The web caching object pool (10) checks if the object has to be cached depending, for example, on HTTP headers and expiring information, or on any other cache management criteria. If the web caching object pool (10) decides to cache the object, the object persistence manager (12) is requested to store the object in the hard disk. Otherwise, the object is only stored in the RAM and no other operation is performed at the hard disk.

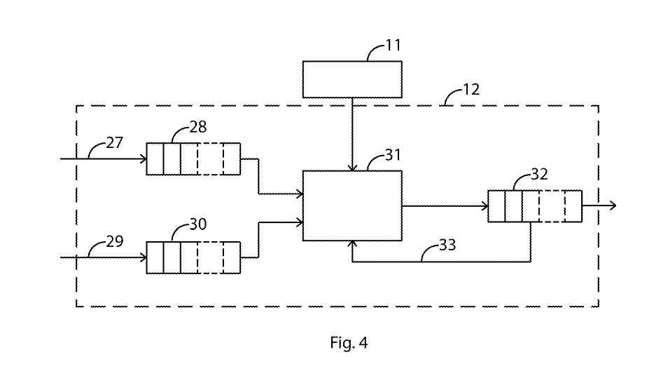

FIG. 4 presents the components of the object persistence manager (12) in order to manage write requests (27) and read requests (29) directed towards the hard disk. Write requests (27), that is, requests to store web content in the hard disk, are queued in a first queue (28) by the web caching object pool (10). Read requests (29), that is, requests to retrieve web content from the hard disk are queued in a second queue (30) by the web caching object pool (10), having the second queue (30) a greater priority than the first queue (28). A disk operation scheduler (31) comprised in the object persistence manager (12) receives information about the status of the hard disk, regarding its data throughput and therefore its saturation level, from the device performance monitor (11), and schedules requests queued in the first queue (28) and second queue (30) into a disk operation queue (32). When the throughput of the hard disk is above a given first threshold, that is, when the hard disk is performing many read and/or write operations, no write requests (27) from the first queue (27) are scheduled through the disk operation queue (32), thus giving priority to read requests (29). However, in scenarios with a low operation load at the hard disk, that is, when the hard disk data throughput is below a second threshold, lower than the first threshold, multiple write requests (27) queued at the first queue (28) may be scheduled through the disk operation queue (32).

The hard disk accesses the items of the disk operation queue (32), that is, the queued read operations (29) and read operations (27) and performs the corresponding tasks (write data into the hard disk or retrieve data from said hard disk). When a disk operation (that is, a read or write operation in the hard disk) is completed (33), the disk operation scheduler may queue more operations in the disk operation queue (32), prioritizing read requests (29). All the queues of the object persistence manager (12) are FIFO queues.

Since requests queued at the object persistence manager (12) may correspond to web content of different sizes, the disk operation scheduler (31) converts these requests into disk operations with a fixed size, that is, disk operations that retrieve or write a fixed number of bits. Also, since write requests (27) can be infinitely delayed in the first queue (28), the object persistence manager (12) periodically checks if the web content related to the write request (27) is expired. If the web content is expired or is close to be expired, the write request (27) is cancelled by the object persistence manager (12), avoiding unnecessary write operations.

The disclosed scheduling architecture and policies allow to prioritize users requests for web content cached in the hard disk versus data storing operations issued by the web caching object pool (10), and therefore improving the overall experience of the user, who perceives a shorter delay when asking for data cached in the hard disk. Also, the method and system may be advantageously combined with any other web caching optimizing technique regarding hardware, allocation criteria, or object replacement techniques.

1. A method of caching web content in a communication node comprising a hard disk memory, said communication node being configured to schedule read requests and write requests of web content in the hard disk, wherein the method comprises:
queuing write requests in a first queue;
queuing read requests in a second queue; the second queue having a greater priority than the first queue;
monitoring a data throughput level of the hard disk;
scheduling write requests queued in the first queue only if the monitored saturation level of the hard disk is below a first threshold; and
scheduling read requests queued in the second queue as a function of the monitored data throughput of the hard disk.

2. The method according to claim 1 wherein the method further comprises scheduling multiple write requests queued in the first queue if the monitored saturation level of the hard disk is below a second threshold.

3. The method according to claim 1 wherein write requests queued in the first queue are divided into data blocks with a fixed size.

4. The method according to claim 1 wherein the first queue is a first in first out queue.

5. The method according to claim 1 wherein the method further comprises checking an expiration of write requests queued in the first queue and removing expired write requests from the first queue.

6. A system of caching web content in a communication node comprising a hard disk memory, said communication node being configured to schedule read requests and write requests of web content in the hard disk, wherein the system further comprises:
first scheduling means configured to queue write requests in a first queue and to queue read requests in a second queue;
monitoring means adapted to monitor a data throughput of the hard disk; and
second scheduling means configured to schedule write requests queued in the first queue only if the monitored saturation level of the hard disk is below a first threshold and to schedule read requests queued in the second queue as a function of the monitored data throughput of the hard disk, giving a greater priority to the second queue.

7. The system according to claim 6 wherein the second scheduling means are further configured to schedule multiple write requests queued in the first queue if the monitored saturation level of the hard disk is below a second threshold.

8. The system according to claim 6 wherein write requests queued in the first queue are divided into data blocks with a fixed size.

9. The system according to claim 6 wherein the first queue is a first in first out queue.

10. The system according to claim 6 wherein the second scheduling means are further configured to check an expiration of write requests queued in the first queue and to remove expired write requests from the first queue.

11. A computer program comprising computer program code means adapted to perform the steps of the method according to claim 1 when said program is run on a computer, a digital signal processor, a field-programmable gate array, an application-specific integrated circuit, a micro-processor, a micro-controller, or any other form of programmable hardware.
